(19) United States
(12) Patent Application Publication
(10) Pub. No.: US 2024/0244427 A1
(43) Pub. Date: Jul. 18, 2024

(54) METHOD AND APPARATUS FOR PROTECTING PRIVACY ISSUE FOR AUTHENTICATION AND KEY MANAGEMENT FOR APPLICATIONS

(71) Applicant: Samsung Electronics Co., Ltd., Suwon-si (KR)

(72) Inventors: Hongjin CHOI, Suwon-si (KR); Junhyun PARK, Suwon-si (KR)

(21) Appl. No.: 18/409,029

(22) Filed: Jan. 10, 2024

(30) Foreign Application Priority Data
Jan. 12, 2023 (KR) 10-2023-0004963

(51) Int. Cl. H04W 12/0431; H04W 12/06; H04W 48/16

(52) U.S. Cl. CPC H04W 12/0431; H04W 12/06; H04W 48/16

(57) ABSTRACT

The disclosure relates to a fifth generation (5G) or sixth generation (6G) communication system for supporting a higher data transmission rate. A method performed by a user equipment (UE) in a communication system is provided. The method includes receiving, from an access and mobility management function (AMF), a non-access stratum (NAS) security mode command message including information on a public key of an authentication and key management for applications (AKMA) anchor function (AAnF), encrypting, based on the public key, a combination of an AKMA temporary identifier (A-TID) and an application function identifier (AF_ID) of an application function (AF), and transmitting, to the AF, an application session establishment request including information on the encrypted combination of the A-TID and the AF_ID.

### CROSS-REFERENCE TO RELATED APPLICATION(S)

This application is based on and claims priority under 35 U.S.C. § 119(a) of a Korean patent application number 10-2023-0004963, filed on Jan. 12, 2023, in the Korean Intellectual Property Office, the disclosure of which is incorporated by reference herein in its entirety.

### BACKGROUND

### 1. Field

The disclosure relates to a wireless communication system. More particularly, the disclosure relates to a method and apparatus for preventing privacy issues in a wireless communication system.

### 2. Description of Related Art

Fifth generation (5G) mobile communication technologies define broad frequency bands such that high data rates and new services are possible, and can be implemented not only in “Sub 6 GHz” bands such as 3.5 GHz, but also in “Above 6 GHz” bands referred to as millimeter wave (mmWave) including 28 GHz, 39 GHz, and the like. In addition, it has been considered to implement sixth generation (6G) mobile communication technologies, which are referred to as Beyond 5G systems, in terahertz (THz) bands (for example, 95 GHz to 3 THz bands) in order to accomplish data rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting various numerologies (for example, operating a plurality of subcarrier spacings, etc.) for efficiently utilizing mmWave resources and dynamic operation of slot formats, initial access technologies for supporting multi-beam transmission and broadbands, definition and operation of Band-Width Part (BWP), new channel coding methods such as a Low Density Parity Check (LDPC) code for large amount of data transmission and a polar code for highly reliable transmission of control information, L2 pre-processing, network slicing for providing a dedicated network specialized to a specific service, and the like.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving technology, Non-Terrestrial Network (NTN) which is UE-satellite direct communication for providing coverage in an area in which communication with terrestrial networks is unavailable, positioning, and the like.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, two-step random access for simplifying random access procedures (2-step random access channel (RACH) for NR), and the like. There also has been ongoing standardization in system architecture/service regarding a 5G baseline architecture (for example, service based architecture or service based interface) for combining Network Functions Virtualization (NFV) and Software-Defined Networking (SDN) technologies, Mobile Edge Computing (MEC) for receiving services based on UE positions, and the like.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, drone communication, and the like.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and method that can effectively provide services in a wireless communication system.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes receiving, from an access and mobility management function (AMF), a non-access stratum (NAS) security mode command message including information on a public key of an authentication and key management for applications (AKMA) anchor function (AAnF).

According to an embodiment of the disclosure, the method includes encrypt, based on the public key, a combination of an AKMA temporary identifier (A-TID) and an application function identifier (AF_ID) of an application function (AF).

According to an embodiment of the disclosure, the method includes transmitting, to the AF, an application session establishment request including information on the encrypted combination of the A-TID and the AF_ID.

According to an embodiment of the disclosure, the method includes transmitting a NAS security mode complete message including information indicating the A-TID to be transmitted with encryption.

According to an embodiment of the disclosure, (i) the encryption of the combination of the A-TID and the AF_ID and (ii) transmission of the application session establishment request may be performed after transmission of the NAS security mode complete message.

According to an embodiment of the disclosure, the method includes receiving, from the AF, an application session establishment response.

According to an embodiment of the disclosure, the method includes identifying, based on the application session establishment response, that AKMA-based security communication with the AF using a common key is available.

According to an embodiment of the disclosure, the common key may be obtained based on the AF_ID and an AKMA key.

According to an embodiment of the disclosure, the A-TID is included an AKMA key identifier (A-KID) for the AKMA key.

According to an embodiment of the disclosure, the NAS security mode command message includes information on a valid time of the public key.

According to an embodiment of the disclosure, the encryption of the combination of the A-TID and the AF_ID may be performed based on the public key in case that the public key is identified as valid based on the valid time.

According to an embodiment of the disclosure, in case that other information on other public key is received prior to the reception of the NAS security mode command message, the other public key may be discarded, and the public key may be used for the encryption.

In accordance with another aspect of the disclosure, a user equipment (UE) in a communication system is provided. The UE includes a transceiver and a processor coupled with the transceiver.

According to an embodiment of the disclosure, the processor may be configured to receive, from an access and mobility management function (AMF), a non-access stratum (NAS) security mode command message including information on a public key of an authentication and key management for applications (AKMA) anchor function (AAnF).

According to an embodiment of the disclosure, the processor may be configured to encrypt, based on the public key, a combination of an AKMA temporary identifier (A-TID) and an application function identifier (AF_ID) of an application function (AF).

According to an embodiment of the disclosure, the processor may be configured to transmit, to the AF, an application session establishment request including information on the encrypted combination of the A-TID and the AF_ID.

According to an embodiment of the disclosure, the processor may be configured to transmit a NAS security mode complete message including information indicating the A-TID to be transmitted with encryption.

According to an embodiment of the disclosure, (i) the encryption of the combination of the A-TID and the AF_ID and (ii) transmission of the application session establishment request may be performed after transmission of the NAS security mode complete message.

According to an embodiment of the disclosure, the processor may be configured to receive, from the AF, an application session establishment response.

According to an embodiment of the disclosure, the processor may be configured to identify, based on the application session establishment response, that AKMA-based security communication with the AF using a common key is available.

According to an embodiment of the disclosure, the common key may be obtained based on the AF_ID and an AKMA key.

According to an embodiment of the disclosure, the A-TID is included an AKMA key identifier (A-KID) for the AKMA key.

According to an embodiment of the disclosure, the NAS security mode command message includes information on a valid time of the public key.

According to an embodiment of the disclosure, the encryption of the combination of the A-TID and the AF_ID may be performed based on the public key in case that the public key is identified as valid based on the valid time.

According to an embodiment of the disclosure, in case that other information on other public key is received prior to the reception of the NAS security mode command message, the other public key may be discarded, and the public key may be used for the encryption.

In accordance with another aspect of the disclosure, a method performed by an application function (AF) in a communication system is provided. The method includes receiving, from a user equipment (UE), an application session establishment request including a combination of an authentication and key management for applications (AKMA) temporary identifier (A-TID) and a first application function identifier (AF_ID).

According to an embodiment of the disclosure, the combination of the A-TID and the first AF_ID may be encrypted based on a public key of an AKMA anchor function (AAnF).

According to an embodiment of the disclosure, the method includes transmitting, to the AAnF, an AKMA application key get request message including information on the encrypted combination of the A-TID and the first AF_ID and information on a second AF_ID of the AF.

According to an embodiment of the disclosure, the method includes receiving, from the AAnF, an AKMA application key get response message including information on a common key associated with the first AF_ID and an AKMA key identifier (A-KID) in case that the first AF_ID is identical to the second AF_ID.

According to an embodiment of the disclosure, the A-KID includes the A-TID.

According to an embodiment of the disclosure, the method includes transmitting, to the UE, an application session establishment response associated with AKMA-based security communication with the UE using the common key being available.

According to an embodiment of the disclosure, the public key may be associated with a private key of the AAnF.

According to an embodiment of the disclosure, the AKMA application key get response message includes information on a valid time of the common key.

According to an embodiment of the disclosure, the AKMA application key get response message may be not received in case that the first AF_ID is different from the second AF_ID.

In accordance with another aspect of the disclosure, an application function (AF) in a communication system is provided. The AF includes a transceiver, and a processor coupled with the transceiver.

According to an embodiment of the disclosure, the processor may be configured to receive, from a user equipment (UE), an application session establishment request including a combination of an authentication and key management for applications (AKMA) temporary identifier (A-TID) and a first application function identifier (AF_ID).

According to an embodiment of the disclosure, the combination of the A-TID and the first AF_ID may be encrypted based on a public key of an AKMA anchor function (AAnF).

According to an embodiment of the disclosure, the processor may be configured to transmit, to the AAnF, an AKMA application key get request message including information on the encrypted combination of the A-TID and the first AF_ID and information on a second AF_ID of the AF.

According to an embodiment of the disclosure, the processor may be configured to receive, from the AAnF, an AKMA application key get response message including information on a common key associated with the first AF_ID and an AKMA key identifier (A-KID) in case that the first AF_ID is identical to the second AF_ID.

According to an embodiment of the disclosure, the A-KID includes the A-TID.

According to an embodiment of the disclosure, the processor may be configured to transmit, to the UE, an application session establishment response associated with AKMA-based security communication with the UE using the common key being available.

According to an embodiment of the disclosure, the public key may be associated with a private key of the AAnF.

According to an embodiment of the disclosure, the AKMA application key get response message includes information on a valid time of the common key.

According to an embodiment of the disclosure, the AKMA application key get response message may be not received in case that the first AF_ID is different from the second AF_ID.

Various embodiments of the disclosure can provide an apparatus and method that can effectively provide services in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a communication network including core network entities in a wireless communication system according to an embodiment of the disclosure;

FIG. 1B illustrates a communication network including core network entities related to AKMA in a wireless communication system according to an embodiment of the disclosure;

FIG. 2A illustrates an example of a functional structure of a terminal according to an embodiment of the disclosure;

FIG. 2B illustrates an example of a functional structure of a base station according to an embodiment of the disclosure;

FIG. 2C illustrates an example of a functional structure of a core network entity according to an embodiment of the disclosure;

FIG. 3A is a flowchart illustrating a UE authentication process and a process for generating material related to AKMA according to an embodiment of the disclosure;

FIG. 3B is a flowchart illustrating a process for protecting and providing A-KID by a UE to an AF according to an embodiment of the disclosure;

FIG. 4A is a flowchart illustrating a UE authentication process and a process for generating material related to AKMA according to an embodiment of the disclosure;

FIG. 4B is a flowchart illustrating a process for protecting and providing A-KID by a UE to an AF according to an embodiment of the disclosure;

FIG. 5 illustrates an example flowchart for a process performed by a UE according to an embodiment of the disclosure; and

FIG. 6 illustrates an example flowchart for a process performed by an AF according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure described below, hardware-wise approach methods will be described by way of an example. However, various embodiments of the disclosure include technology using both hardware and software, and thus do not exclude software-based approach methods.

In the disclosure, a/b/c may be understood as at least one of a, b, and c.

3^{rd}-Generation Partnership Project (3GPP) that is in charge of cellular mobile communication standards has named a new core network structure a 5G core (5GC), in order to accomplish evolution from existing fourth generation (4G) long term evolution (LTE) systems to 5G systems, and has been conducting standardization. The 5GC provides the following differentiated functions compared with the evolved packet core (EPC), which is the existing network core for 4G.

Firstly, the 5GC has introduced a network slice function. As a requirement of 5G, the 5GC needs to support various kinds of terminal types and services (examples: eMBB, URLLC, or mMTC service). Various kinds of services have different requirements for the core network, respectively. For example, the eMBB service requires a high data rate, and the URLLC service requires high stability and low latency. A network slice scheme has been proposed as a technology for satisfying such various service requirements.

The network slice scheme is a method for virtualizing a physical network to obtain multiple logical networks, and respective network slice instances (NSI) may have different characteristics. Accordingly, respective NSIs have network functions (NFs) conforming to characteristics thereof and can satisfy various service requirements. Respective terminals are assigned with NSIs according to the characteristics of required services such that various 5G services can be supported efficiently.

Secondly, the 5GC can facilitate network virtualization paradigm support through separation between a mobility management function and a session management function. In 4G long term evolution (LTE), all terminals can be provided with services through signaling exchange with single core equipment referred to as a mobility management entity (MME) that is in charge of registration, authentication, mobility management, and session management functions. However, in the 5G, the number of terminals increases exponentially, and the mobility and traffic/session characteristics that need to be supported according to terminal types are subdivided. Accordingly, if all functions are supported by single equipment such as the MME, the scalability to add entities according to required functions is inevitably degraded. Therefore, various functions are being developed on the basis of a structure that separates the mobility management function and the session management function, in order to improve the scalability, in terms of the signaling load and the complexity of the function/implementation of the core equipment that is in charge of the control plane.

Meanwhile, a function called authentication and key management for applications (AKMA) is being newly introduced and used in 5G. Application function (AF), which operates as an application server using the AKMA function, requires a common key (K_af (K_AF)) for secure communication with the UE. The AF may receive a corresponding key from AKMA anchor function (AAnF), one of the network functions of the 3GPP system. When the AF delivers the A-KID received from the UE and its own ID, AF_ID, to the AAnF, the AAnF may find K_akma (K_AKMA) from A-KID, create K_af using K_akma and AF_ID, and then provide K_af and UE's ID, SUPI or GPSI to the AF. However, when the AKMA function is used, an attack that violates user privacy may be occurred. For example, when the UE transmits a message including A-KID to AF1, malicious AF2 may monitor the message and find out the A-KID value and which AF (in this case, AF1) the UE is communicating with. If malicious AF2 has registered the AKMA service with a corresponding operator, the AF2 can obtain the ID (SUPI or GPSI) of the UE by requesting its ID, AF2_ID and A-KID, from AAnF. In that case, the AF2 can find out which UE is communicating with which AF, which may lead to a violation of user privacy.

The authentication and key management for applications (AKMA) is used for secure communication between UE and application server (AF: Application Function) in a wireless system. The UE and AUSF create K_akma from K_ausf and create AKMA Key Identifier (A-KID) referring to K_akma. Since A-KID is created by combining K_ausf and SUPI, it may operate as a temporary ID of the UE. Then, the AUSF may deliver SUPI, A-KID, and K_akma to AKMA anchor function (AAnF). If the UE intends to use AKMA for secure communication with the application server, the UE provides the A-KID to the application server. The application server provides AAnF with its own ID, AF_ID, and the A-KID received from the UE. After finding K_akma corresponding to A-KID, the AAnF creates K_af using AF_ID and K_akma and delivers the created K_af to the application server. The UE may also proceed with secure communication by creating K_af in the same way. However, if another application server monitors the communication in which the UE provides the A-KID to the application server, information such as what application is installed on the corresponding UE and which application server it is trying to connect to can be identified. If the application server that has monitored the communication can provide the A-KID to the AAnF to receive the generic public subscription identifier (GPSI) or subscription permanent identifier (SUPI) of the corresponding UE, it is possible to determine which UE is communicating with which application server. Because of this, privacy issues may exist.

Based on the above-described discussion, the disclosure is to provide a method and apparatus for preventing privacy issues when using AKMA.

According to various embodiments of the disclosure, before delivering the A-KID to the AF, the UE that has received the public key of the AAnF may encrypt (A-KID_AF) the ID (AF_ID) of the corresponding AF, the public key of AAnF, and the A-TID portion of the A-KID (A-KID_AF) and deliver them to the AF. The AF that has received this may deliver the A-KID_AF and AF_ID to the AAnF to request K_af and the UE ID (SUPI or GPSI). The AAnF may decrypt the encrypted portion of the A-KID_AF with AAnF's private key, identify whether the AF_ID of the decrypted portion matches the ID of the AF that has made the request, and then find the K_akma corresponding to A-KID to create K-aF, and then deliver the created K_af together with the UE ID (SUPI or GPSI) to the AF.

Hereinafter, various embodiments will be described in detail with the accompanying drawings. In addition, in describing embodiments of the disclosure, a detailed description of known functions or constitution incorporated herein will be omitted in case where it is determined that the description may make the subject matter of the embodiments unnecessarily unclear. The terms which will be described below are terms defined in consideration of the functions in the embodiments, and may be different according to users, intentions of the operators, or customs. Therefore, the definitions of the terms should be made based on the contents throughout the specification.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The embodiments are provided only to completely disclose the disclosure and inform those skilled in the art of the scope of the disclosure, and the disclosure is defined only by the scope of the appended claims. Throughout the disclosure, like reference numerals denote like elements.

Herein, it will be understood that each block of the flowchart illustrations, and combinations of blocks in the flowchart illustrations, can be implemented by computer program instructions. These computer program instructions can be loaded on a processor of a general-purpose computer, special purpose computer, or other programmable data processing apparatus, so that the instructions, which execute via the processor of the computer or other programmable data processing apparatus, create means for implementing the functions specified in the flowchart block(s). These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block(s). Since the computer program instructions may also be loaded onto a computer or other programmable data processing apparatus, a series of operational steps is performed on the computer or other programmable data processing apparatus to produce a computer implemented process such that the instructions that execute on the computer or other programmable data processing apparatus provide steps for implementing the functions specified in the flowchart block(s).

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Herein, as used in various embodiments of the disclosure, the “unit” refers to a software element or a hardware element, such as a field programmable gate array (FPGA) or application-specific integrated circuit (ASIC), which performs a predetermined function. However, the “unit” does not always have a meaning limited to software or hardware. The “unit” may be constructed either to be stored in an addressable storage medium or to reproduce one or more processors. Therefore, the “unit” includes, for example, elements, such as software elements, object-oriented software elements, class elements and task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, and “units”, or divided into additional elements, and “units”. Moreover, the elements and “units” may be implemented to reproduce one or more CPUs within a device or a security multimedia card.

Hereinafter, the base station may be an entity allocating resource to terminal and may be at least one of eNodeB (eNB), Node B, base station (BS), radio access network (RAN), access network (AN), RAN node, NR NB, gNB, wireless access unit, base station controller, and node over network. The terminal may include user equipment (UE), mobile station (MS), cellular phone, smartphone, computer, or multimedia system capable of performing communication functions. In various embodiments of the disclosure, a case where the terminal is a UE will be described as an example. Further, although LTE-, LTE-A- or NR-based system is described in connection with various embodiments of the disclosure, as an example, various embodiments of the disclosure may also apply to other communication systems with similar technical background or channel form. Further, various embodiments of the disclosure may be modified in such a range as not to significantly depart from the scope of the disclosure under the determination by one of ordinary skill in the art and such modifications may be applicable to other communication systems.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

Further, the disclosure describes various embodiments using the terms used in some communication standards (for example, 3^{rd}-Generation Partnership Project (3GPP)), but this is only an example. Various embodiments of the disclosure may be easily modified and applied to other communication systems. Hereinafter, some terms used in the core network of the disclosure are defined in advance.
AMF: Access and Mobility Management Function
CN: Core Network
CNF: Containerized Network Function
DNN: Data Network Name
PCF: Policy Control Function
HSS: Home Subscriber Server
SMF: Session Management Function
UDM: User Data Management
UPF: User Plane Function
CNF: Containerized Network Function
VNF: Virtual Network Function

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

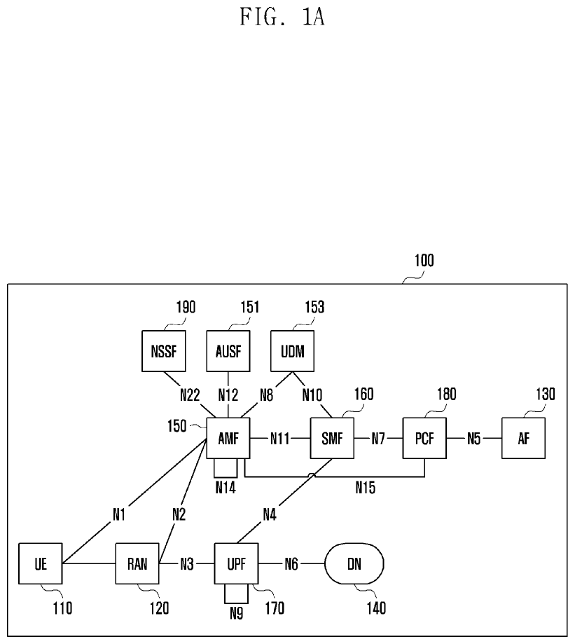

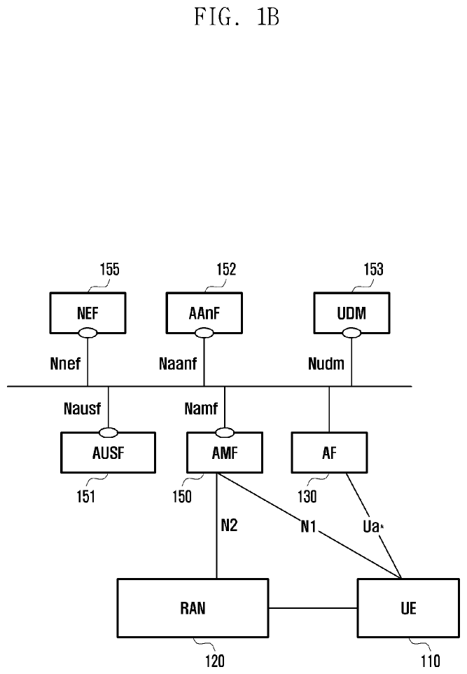

FIG. 1A illustrates a communication network including core network entities in a wireless communication system according to an embodiment of the disclosure. A 5G mobile communication network may be constituted to include a 5G user equipment (UE) 110, a 5G radio access network (RAN) 120, and a 5G core network.

The 5G core network 100 may be constituted to include network functions such as, an access and mobility management function (AMF) 150 for providing a mobility management function of the UE, a session management function (SMF) 160 for providing a session management function, a user plane function (UPF) 170 for performing data transfer, a policy control function (PCF) 180 for providing a policy control function, a unified data management (UDM) 153 for providing a function of managing data such as subscriber data and policy control data, or a unified data repository (UDR) for storing data of various network functions.

Referring to FIG. 1A, a user equipment (UE) 110 may perform communication through a radio channel established with a base station (e.g., eNB or gNB), that is, an access network. In some embodiments, the UE 110 is a device used by a user and may be a device constituted to provide a user interface (UI). As an example, the UE 110 may be equipment mounted on a vehicle for driving. In some other embodiments, the UE 110 may be a device that performs machine type communication (MTC) operated without user involvement, or may be an autonomous vehicle. The UE may be referred to, in addition to an electronic device, as terms such as a ‘terminal’, ‘vehicle terminal’, ‘user equipment (UE)’, ‘mobile station’, ‘subscriber station’, ‘remote terminal’, ‘wireless terminal’, ‘user device’, or other terms having equivalent technical meaning. A customer-premises equipment (CPE) or dongle type terminal may be used, as the terminal, in addition to the UE. The customer premises device may provide a network to other communication equipment (e.g., laptop) while being connected to an NG-RAN node like the UE.

Referring to FIG. 1A, an AMF 150 provides a function for access and mobility management in units of UE 110, and each UE 110 may be basically connected to one AMF 150. Specifically, the AMF 150 may perform at least one function among signaling between core network nodes for mobility between 3GPP access networks, an interface (N2 interface) between radio access networks (e.g., 5G RAN) 120, NAS signaling with the UE 110, identification of the SMF 160, and transmission and providing of a session management (SM) message between the UE 110 and the SMF 160. Some or all of the functions of the AMF 150 may be supported within a single instance of one AMF 150.

Referring to FIG. 1A, the SMF 160 provides a session management function, and in case where the UE 110 has multiple sessions, each session may be managed by a different SMF 160. Specifically, the SMF 160 may perform at least one function among session management (e.g., establishment, modification, and release of a session including maintenance of a tunnel between the UPF 170 and an access network node), selection and control of a user plane (UP) function, configuration of traffic steering for routing traffic to an appropriate destination from the UPF 170, termination of an SM part of a NAS message, downlink data notification (DDN), and an initiator of AN-specific SM information (e.g., transmission to an access network through an N2 interface via the AMF 150). Some or all functions of the SMF 160 may be supported within a single instance of one SMF 160.

In the 3GPP system, conceptual links connecting between NFs in the 5G system may be referred to as a reference point. The reference point (hereinafter used interchangeably with an interface) may also be referred to as an interface. Reference points included in the 5G system architecture represented through various embodiments of the disclosure are illustrated as follows.
Ua*: Reference point between AF 130 and UE 110.
N1:Reference point between UE 110 and AMF 150.
N2: Reference point between RAN 120 and AMF 150.
N3: Reference point between RAN 120 and UPF 170.
N4: Reference point between SMF 160 and UPF 170.
N5: Reference point between PCF 180 and AF 130.
N6: Reference point between UPF 170 and DN 140.
N7: Reference point between SMF 160 and PCF 180.
N8: Reference point between UDM 153 and AMF 150.
N9: Reference point between two core UPFs 170.
N10: Reference point between UDM 153 and SMF 160.
N11: Reference point between AMF 150 and SMF 160.
N12: Reference point between AMF 150 and authentication server function (AUSF) 151.
N13: Reference point between UDM 153 and AUSF 151.
N14:reference point between two AMFs 150.
N15: reference point between PCF 180 and AMF 150 in the case of non-roaming scenario, and reference point between PCF 180 within visited network and AMF 150 in the case of roaming scenario.
N22: reference point between network slice selection function (NSSF) 190 and AMF 150.
Nnef: Service-based interface exhibited by NEF.
Naanf: Service-based interface exhibited by AAnf.
Nudm: Service-based interface exhibited by UDM.
Nausf: Service-based interface exhibited by AUSF.
Namf: Service-based interface exhibited by AMF.

FIG. 1B illustrates a communication network including core network entities related to AKMA in a wireless communication system.

Referring to FIG. 1B, the wireless communication system includes a radio access network (RAN) 120 and a core network (CN).

The RAN 120 is a network directly connected to a user equipment, for example, the UE 110, and is an infrastructure which provides radio access to the UE 110. The RAN 120 includes a set of a plurality of base stations, including the base station 125, and the plurality of the base stations may perform communication through an interface formed therebetween. At least some of the interfaces between the plurality of the base stations may be wired or wireless. The base station 125 may have a structure divided into a central unit (CU) and a distributed unit (DU). In this case, one CU may control a plurality of DUs. In addition to the base station, the base station 125 may be referred to as an ‘access point (AP)’, a ‘next generation node B (gNB)’, a ‘5th generation (5G) node’, a ‘wireless point’, a ‘transmission/reception point (TRP)’ or other term having the technically identical meaning. The UE 110 may access the RAN 120 and may perform communication with the base station 125 through a radio channel. The UE 110 may be referred to as, in addition to a terminal, a “user equipment (UE)”, a “mobile station”, a “subscriber station”, a “remote terminal”, a “wireless terminal”, a “user device”, or other terms having equivalent technical meanings.

The core network, which is a network which manages the whole system, controls the RAN 120 and processes data and control signals for the UE 110 transmitted and received via the RAN 120. The core network performs various functions such as controlling a user plane and control plane, mobility processing, subscriber information management, charging, and interworking with other types of systems (e.g., a long term evolution (LTE) system). To perform the various functions as described above, the core network may include a plurality of entities functionally separated with different network functions (NFs). For example, the core network 200 may include an access and mobility management function (AMF) 150, a session management function (SMF) 160, a user plane function (UPF) 170, a PCF 180, a network repository function (NRF) 159, a unified data management (UDM) 153, a network exposure function (NEF) 155, a unified data repository (UDR) 157, an AUSF 151, an AKMA anchor function (AAnF) 152.

The UE 110 is connected to the RAN 120 and accesses the AMF 150, which performs the mobility management function of the core network. The AMF 150 is a function or device that is responsible for both access to the RAN 120 and mobility management of the UE 110. The SMF 160 is an NF which manages a session. The AMF 150 is connected to the SMF 160, and the AMF 150 routes session-related messages for the UE 110 to the SMF 160. The SMF 160 is connected to the UPF 170, allocates a user plane resource to be provided to the UE 110, and establishes a tunnel to transmit data between the base station 125 and the UPF 170. The PCF 180 controls information related to a policy and charging for a session used by the UE 110. The AUSF 151 performs a role related to the authentication of the UE 110.

The NRF 159 performs a function of storing information about NFs installed in a mobile communication service provider network and notifying of the stored information. The NRF 159 may be connected to all NFs. When starting operation in a service provider network, each NF provides, to the NRF 159, a notification that a corresponding NF is being operated in the network, by performing registration in the NRF 159. The UDM 153 is an NF to perform a function similar to that of a home subscriber server (HSS) of a 4G network, and stores subscription information of the UE 110 or context used by the UE 110 in the network.

The NEF 155 serves to connect a 3rd party server and an NF in the 5G mobile communication system. In addition, the NEF serves to provide data to the UDR 157, or update or acquire data. The UDR 157 performs a function to store subscription information of the UE 110, store policy information, store data exposed to the outside, or store information required for a 3rd party application. In addition, the UDR 157 also serves to provide stored data to another NF.

The AF 130 is a network function that operates as an application server, and may be a 3rd party server or an application server within a service provider's network function. The AAnF 152 is a network function related to the AKMA function, and receives information such as K_akma, SUPI, and A-KID from the AUSF 151.

If later receiving a request including A-KID and AF_ID from the AF 130, the AAnF 152 creates K_af from K_akma and AF_ID, and then may transmit information such as UE ID (SUPI or GPSI), K_af, and the effective time of K_af to the AF.

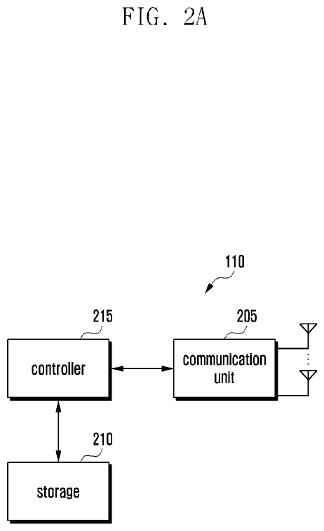

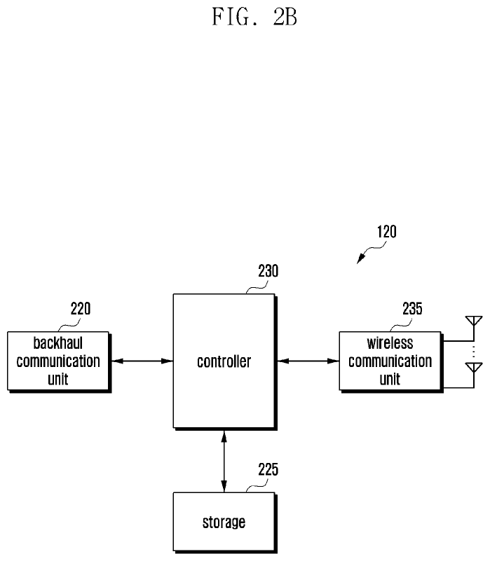

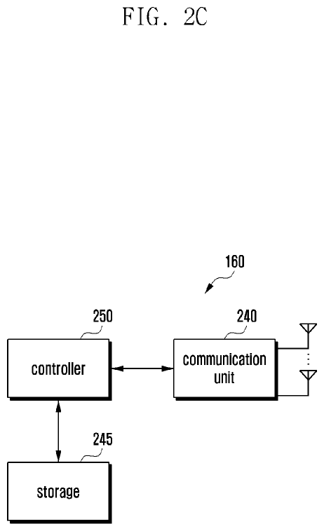

FIG. 2A illustrates an example of a functional structure of a terminal according to an embodiment of the disclosure. The structure illustrated in FIG. 2A may be understood as the structure of the UE 110. A term such as ‘ . . . unit’ or ‘ . . . er’ used hereafter indicates a unit for processing at least one function or operation, and may be implemented using hardware, software, or a combination of hardware and software.

Referring to FIG. 2A, the UE includes a communication unit 205, a storage 210, and a controller 215.

The communication unit 205 performs functions for transmitting and receiving a signal through a radio channel. For example, the communication unit 205 performs a function of conversion between a baseband signal and a bitstream according to the physical-layer standard of the system. For example, in data transmission, the communication unit 205 may encode and modulate a transmission bitstream to generate complex symbols. Also, in data reception, the communication unit 205 reconstructs a reception bitstream by demodulating and decoding a baseband signal. Also, the communication unit 205 up-converts a baseband signal into a RF band signal, transmits the RF band signal through an antenna, and down-converts an RF band signal received through an antenna into a baseband signal. For example, the communication unit 205 may include a transmission filter, a reception filter, an amplifier, a mixer, an oscillator, a digital-to-analog convertor (DAC), an analog-to-digital convertor (ADC), and the like.

Also, the communication unit 205 may include a plurality of transmission/reception paths. In addition, the communication unit 205 may include at least one antenna array including a plurality of antenna elements. From the perspective of hardware, the communication unit 205 may be constituted with a digital circuit and an analog circuit (for example: radio frequency integrated circuit (RFIC)). Herein, the digital circuit and analogue circuit may be implemented as one package. Also, the communication unit 205 may include a plurality of RF chains. Furthermore, the communication unit 205 may perform beamforming.

The communication unit 205 may transmit and receive a signal as described above. Accordingly, the entirety or part of the communication unit 205 may be referred to as a “transmitter,” “receiver,” or “transceiver.” Also, the transmission and reception performed via a radio channel, which is described in the following descriptions, may be understood to include the case in which the above-described processing is performed by the communication unit 205.

The storage 210 stores data such as a basic program for the operation of the UE, an application program, and configuration information. The storage 210 may include a volatile memory, a nonvolatile memory or a combination of a volatile memory and nonvolatile memory. In addition, the storage 210 provides the stored data at a request of the controller 215.

The controller 215 controls overall operations of the UE. For example, the controller 215 transmits and receives signals through the communication unit 205. In addition, the controller 215 records data in the storage 210 and reads the recorded data. Further, the controller 215 may perform the functions of a protocol stack that the communication standard requires. To this end, the controller 215 may include at least one processor or microprocessor, or may be a part of a processor. In addition, a part of the communication unit 205 and controller 215 may be referred to as a communication processor (CP). According to various embodiments, the controller 215 may use wireless communication network control to perform synchronization. For example, the controller 215 may control the UE to perform operations according to various embodiments described below.

According to various embodiments of the disclosure, the UE may include a mobile equipment (ME) and a universal mobile telecommunications service (UMTS) subscriber identity module (USIM). The ME may include a mobile terminal (MT) and terminal equipment (TE). The MT may be the part where the radio access protocol operates, and the TE may be the part where the control function operates. For example, in case of a wireless communication UE (e.g., a mobile phone), the MT and TE may be integrated, and in case of a laptop, the MT and TE may be separated. In the disclosure, depending on the operation of each component, the ME and USIM may be expressed as distinct entities, but are not limited thereto, and it is apparent that the ME and USIM may be expressed as a terminal (e.g., UE), or the ME may be expressed as a terminal for describing various embodiments of the disclosure.

FIG. 2B illustrates an example of a functional structure of a base station according to an embodiment of the disclosure. The structure illustrated in FIG. 2B may be understood as the structure of a base station of the RAN 120. A term such as ‘ . . . unit’ or ‘ . . . er’ used hereafter indicates a unit for processing at least one function or operation, and may be implemented using hardware, software, or a combination of hardware and software.

Referring to FIG. 2B, the base station includes a wireless communication unit 235, a backhaul communication unit 220, a storage 225, and a controller 230.

The wireless communication unit 235 performs functions for transmitting and receiving a signal through a radio channel. For example, the wireless communication unit 235 performs a function of conversion between a baseband signal and a bitstream according to the physical-layer standard of the system. For example, in data transmission, the wireless communication unit 235 may encode and modulate a transmission bitstream to generate complex symbols. Also, in data reception, the wireless communication unit 235 reconstructs a reception bitstream by demodulating and decoding a baseband signal.

Also, the wireless communication unit 235 up-converts a baseband signal into a radio frequency (RF) band signal, transmits the RF band signal through an antenna, and down-converts an RF band signal received through an antenna into a baseband signal. To do this, the wireless communication unit 235 may include a transmission filter, a reception filter, an amplifier, a mixer, an oscillator, a Digital-to-Analog Convertor (DAC), an Analog-to-Digital Convertor (ADC), and the like. Further, the wireless communication unit 235 may include a plurality of transmission/reception paths. In addition, the wireless communication unit 235 may include at least one antenna array including a plurality of antenna elements.

On the hardware aspect, the wireless communication unit 235 may include a digital unit and an analog unit, and the analog unit may include a plurality of sub-units according to operating power, operating frequency, and the like. The digital unit may be implemented by at least one processor (for example, a Digital Signal Processor (DSP)).

The wireless communication unit 235 may transmit and receive a signal as described above. Accordingly, the entirety or part of the wireless communication unit 235 may be referred to as a “transmitter,” “receiver,” or “transceiver.” Also, the transmission and reception performed via a radio channel, which is described in the following descriptions, may be understood to include the case in which the above-described processing is performed by the wireless communication unit 235.

The backhaul communication unit 220 provides an interface for performing communication with other nodes within the network. That is, the backhaul communication unit 220 may convert, into a physical signal, a bitstream transmitted from the base station to another node, for example, another access node, another base station, an upper node, a core network, and the like, and may convert a physical signal received from another node into a bitstream.

The storage 225 may store data, such as a basic program for operating the base station, an application program, configuration information, and the like. The storage 225 may be implemented as volatile memory, nonvolatile memory, or a combination of volatile memory and nonvolatile memory. In addition, the storage 225 may provide data stored therein in response to a request from the controller 230.

The controller 230 controls the overall operation of the base station. For example, the controller 230 may transmit and receive a signal via the wireless communication unit 235 or backhaul communication unit 220. Further, the controller 230 records data in the storage 225 and reads the recorded data. The controller 230 may perform the functions of a protocol stack that the communication standard requires. According to another implementation example, the protocol stack may be included in the wireless communication unit 235. To do this, the controller 230 may include at least one processor. According to various embodiments, the controller 230 may use wireless communication network control to perform synchronization. For example, the controller 230 may control the base station to perform operations according to various embodiments described below.

FIG. 2C illustrates an example of a functional structure of a core network entity according to an embodiment of the disclosure. The structure of a core network entity in a wireless communication system according to various embodiments of the disclosure is illustrated. The structure illustrated in FIG. 2C may be understood as the structure of an apparatus including at least one function among the network entities including the AMF 150 of FIG. 1. A term such as ‘ . . . unit’ or ‘ . . . er’ used hereafter indicates a unit for processing at least one function or operation, and may be implemented using hardware, software, or a combination of hardware and software.

Referring to FIG. 2C, the core network entity includes a communication unit 240, a storage 245, and a controller 250.

The communication unit 240 provides an interface for communicating with other apparatuses within the network. That is, the communication unit 240 converts a bitstream transmitted from the core network entity to another apparatus into a physical signal, and converts a physical signal received from another apparatus into a bitstream. That is, the communication unit 240 may transmit and receive signals. Accordingly, the communication unit 240 may be referred to as a modem, a transmitter, a receiver, or a transceiver. In this case, the communication unit 240 allows the core network entity to communicate with other apparatuses or systems through a backhaul connection (for example, wired backhaul or wireless backhaul) or network.

The storage 245 stores data such as a basic program for the operation of the core network entity, an application program, and configuration information. The storage 245 may include a volatile memory, a nonvolatile memory or a combination of a volatile memory and nonvolatile memory. In addition, the storage 245 provides the stored data at a request of the controller 250.

The controller 250 controls overall operations of the core network entity. For example, the controller 250 transmits and receives signals through the communication unit 240. In addition, the controller 250 records data in the storage 245 and reads the recorded data. To this end, the controller 250 may include at least one processor. According to various embodiments, the controller 250 may use wireless communication network control to perform synchronization. For example, the controller 250 may control the core network entity to perform operations according to various embodiments described below.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

Hereinafter, for convenience of the following description, the disclosure uses terms and names defined in a 5G system (5GS) and a New Radio (NR) standard, which are the latest standards defined by 3GPP in existing communication standards. However, the disclosure is not limited by the above terms and names, and may be equally applied to wireless communication networks conforming to other standards. In particular, the disclosure is applicable to 3GPP 5 generation mobile communication standards (e.g., 5GS and NR).

Unless specifically stated otherwise, “protecting” specific information in the disclosure may be understood as “encrypting” the specific information.

As described above, a fake base station may steal or forge the system information of a genuine base station that the UE needs to connect to. Various methods may be required to solve these problems.

This disclosure relates to a method and apparatus for preventing privacy issues by protecting AKMA Key Identifier (A-KID) in case where a UE uses authentication and key management for applications (AKMA) for secure communication with AF in a wireless communication system.

According to an embodiment of the disclosure, a method performed by a UE in a wireless communication system may be provided. The method may include receiving information from an AMF; if a public key of AAnF is received from the information, determining by a UE that the UE must protect A-KID using the public key of the AAnF and transmit the protected A-KID to an AF; transmitting an indicator, to the AMF, an indicator indicating that the UE protects the A-KID with the public key of the AAnF and transmits the protected A-KID to the AF; generating A-KID_AF by combining AKMA temporary Identifier (A-TID) of the A-KID, ID of the AF, and public key of the AAnF; delivering the A-KID_AF to an application server; and receiving the public key of AAnF and/or validity time from an UDM through an UPU process, discarding the public key of the AAnF whose validity time has expired, and then storing a newly received public key of AAnF and/or validity time.

According to an embodiment of the disclosure, a method performed by AAnF in a wireless communication system may include generating a public key/private key pair of AAnF; registering the public key of the AAnF in an UDM; receiving an indicator indicating that a UE protects the A-KID with the public key of the AAnF and transmits the protected A-KID to an AF; receiving A-KID_AF from the AF; decrypting an encrypted part of the A-KID_AF with the private key of the AAnF; and determining whether the AF_ID of the decrypted A-KID_AF is the same as the ID of the AF that has made a corresponding request.

For more detailed information on the operation of the above-described UE and AAnF, the description of an embodiment of the disclosure described below is referred. Meanwhile, although the above-described UE and AAnF operations have been described as a series of operations, the respective operations may overlap, occur in parallel, occur in a different order, or occur multiple times. In other examples, the operations may be omitted or replaced with other operations.

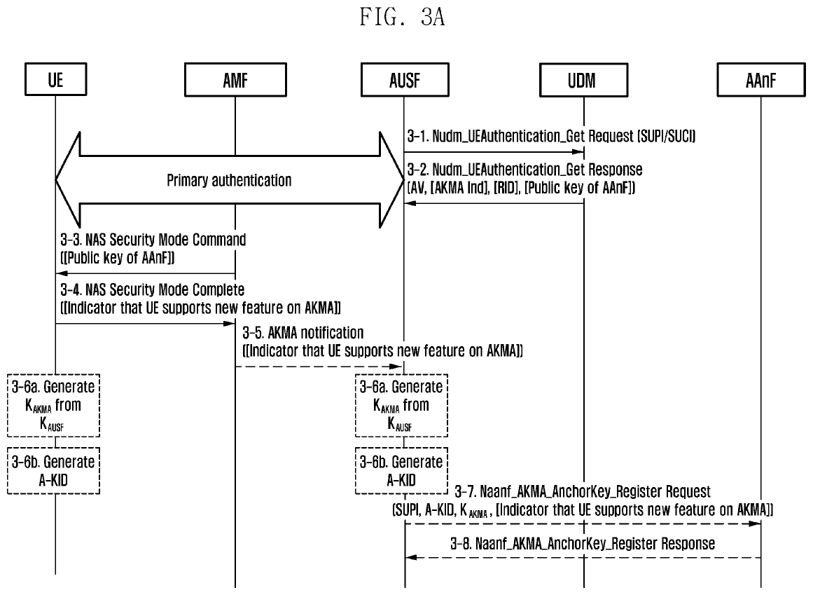

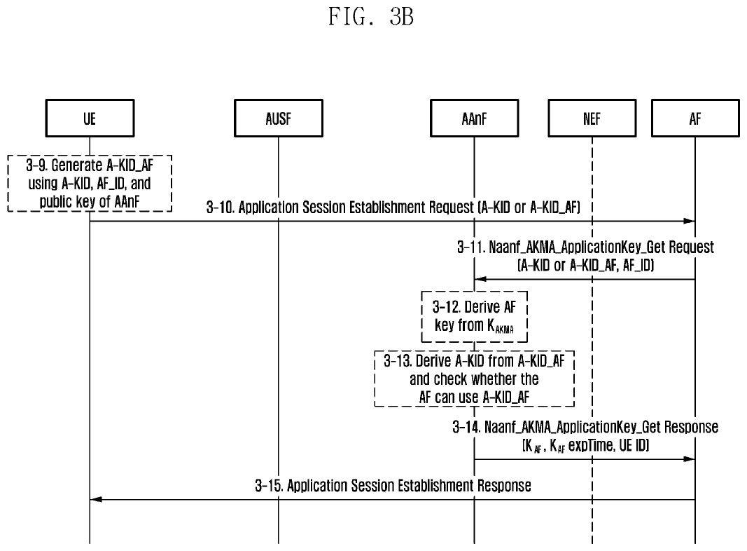

FIG. 3A is a flowchart illustrating a UE authentication process and a process for generating material related to AKMA according to an embodiment of the disclosure.

FIG. 3B is a flowchart illustrating a process for protecting and providing A-KID by a UE to an AF according to an embodiment of the disclosure.

Various modifications may be made to the method illustrated in the flowcharts of FIGS. 3A and 3B. For example, although shown as a series of operations, various operations in each figure may overlap, occur in parallel, occur in a different order, or occur multiple times. In other examples, operations may be omitted or replaced with other operations.

For the procedures illustrated in FIGS. 3A and 3B, one or more of the following configurations may be performed in advance.

### First Pre-Configuration

AAnF may generate a public/private key pair. The validity time for the corresponding public key/private key may be generated together.

### Second Pre-Configuration

AAnF may register the generated public key and/or validity time in UDM. The fact that the public key of AAnF is transmitted to the UDM may be understood as indicating that AAnF is capable of supporting a function according to an embodiment described later, or as an indicator thereof.

Referring to FIG. 3A, the UE may perform a primary authentication process when first accessing a network.

In operation 3-1, an AUSF may request the Nudm_UEAuthentication_GetRequest service by providing SUPI or subscription concealed identifier (SUCI) to an UDM.

In operation 3-2, if SUCI is received in operation 1, the UDM may convert SUCI to SUPI, and if SUPI is received, the UDM may find K, a long term credential for the corresponding SUPI. K, a long term credential, may be a value stored in the USIM and UDM of the UE. The UDM may generate an authentication vector (AV) (for example, including CK′ and IK′ generated from K in case of EAP-AKA′, or K_ausf in case of 5G-AKA) using K of the corresponding UE. In response to operation 3-1, the UDM may transmit Nudm_UEAuthentication_GetResponse including at least one of an authentication vector, an AKMA indication indicating that the corresponding UE may use an AKMA service, a routing indicator (RID) used to find the AAnF, the public key of the AAnF, and the validity time of the public key of the AAnF. The AUSF that has received the authentication vector may obtain K_ausf (for example, in case of EAP-AKA′, the AUSF may directly obtain K_ausf using CK′ and IK′, and in case of 5G-AKA, the AUSF may receive the K-ausf generated from the UDM). The AUSF may generate K_seaf from the K_ausf and deliver the K_seaf to the security anchor function (SEAF) of a serving network, and the SEAF may use the K_seaf to generate K_amf and then deliver the K_amf to the AMF. The above keys (K_ausf, K_seaf, K_amf, etc.) may also be generated in the UE using the same algorithm and input values. However, the order of generating may be simultaneous or different.

In operation 3-3, the AMF may transmit a non-access stratum (NAS) security mode command message by adding the public key of the AAnF and/or the validity time of the public key to the NAS security mode command message. The UE, which has received the public key of the AAnF, may determine that when transmitting the A-KID to the AF, the UE must protect (encrypt) the A-KID using the corresponding key and transmit the A-KID. The AMF may identify cipher and integrity protection algorithms related to transmission and reception of the NAS messages to and from the UE. The AMF may identify the cipher and integrity protection algorithms related to transmission and reception of the NAS messages based on the information on cipher and integrity protection algorithms supported by the UE received from the UE. The AMF may generate a cipher key or integrity protection key for NAS based on the identified algorithm and K_amf, etc. The AMF may transmit the NAS security mode command message with integrity protection using the generated integrity protection key for the NAS. The NAS security mode command message may be a first integrity-protected message among NAS messages. According to one embodiment, an integrity-protected message may not be arbitrarily modified by other entities until it is received by the UE. The NAS message may include at least one of a cipher algorithm and integrity protection algorithm selected by the AMF. Alternatively, although not shown in the figure, the AAnF public key and/or the validity time of the public key may be transmitted through a cipher or integrity-protected message (for example, a registration complete message) rather than the NAS security mode command message.

In operation 3-4, the UE may transmit, to the NAS security mode complete message, an indicator indicating that the UE protects and transmits the A-KID using the public key of the AAnF. That is, the NAS security mode complete message may include an indicator (that UE supports new feature on AKMA) indicating that the UE protects and transmits the A-KID using the public key of the AAnF. According to one embodiment, the UE may generate a cipher key and integrity protection key for the NAS based on the cipher algorithm and integrity protection algorithm received from the AMF in operation 3-3. The UE may transmit a subsequent NAS message, including the NAS security mode complete message, based on the generated keys with cipher and integrity protections.

In operation 3-5, the AMF may inform the AUSF of the indicator received from the UE in operation 3-4.

In operation 3-6a and operation 3-6b, the UE and AUSF may generate K_akma and A-KID. Regarding the order of generating the above parameters, the UE and AUSF may generate them simultaneously or at different times. The UE and AUSF may generate K_akma using input values such as K_ausf, SUPI, and the string “AKMA” generated in operation 3-2. The A-KID is basically an ID representing K_akma and may include username@realm. The Username part may include routing indicator (RID) and AKMA temporary Identifier (A-TID), and the realm part may include home network identifier. The A-TID may be generated using the string “A-TID”, SUPI, K_ausf, etc. as an input.

In operation 3-7, the AUSF may transmit to the AAnF including at least one of K_akma, A-KID, SUPI, and an indicator indicating that the UE protects and transmits the A-KID using the public key of the AAnF. That is, the AUSF may transmit a key registration request message (Naanf_AKMA_AnchorKey_RegisterRequest) including at least one of K_akma, A-KID, SUPI, and an indicator indicating that the UE protects and transmits the A-KID using the public key of AAnF.

In operation 3-8, the AAnF may respond to the key registration request message. The AAnF may transmit a key registration response message (Naanf_AKMA_AnchorKey_RegisterResponse) in response to the key registration request message.

In operation 3-9, if the UE has received the public key of the AAnF in operation 3-3, the UE may generate A-KID_AF using A-KID, AF_ID, and the public key of the AAnF. The method for the UE to generate the A-KID_AF may be to replace the A-TID part of the A-KID with a value obtained by encrypting A-TID+AF_ID with the public key of the AAnF. That is, the value obtained by encrypting A-TID+AF_ID with the public key of the AAnF is replaced with the A-TID part of A-KID, and A-KID_AF may be generated. In other words, the A-TID part of A-KID may be replaced with the value obtained by encrypting A-TID+AF_ID with the public key of AAnF. Another way for the UE to generate A-KID_AF using the public key of the AAnF is for the UE to generate a temporary public key and temporary private key pair, and then generate a session key by combining the public key of the AAnF and its own temporary private key pair. The corresponding method may be a method for replacing the A-TID part of A-KID with a value obtained by encrypting A-TID+AF_ID using the generated session key. That is, the value obtained by encrypting A-TID+AF_ID with the generated session key is replaced with the A-TID part of A-KID, and A-KID_AF may be generated. The temporary public key generated by the UE may also be transmitted here.

In operation 10, the UE may transmit A-KID or A-KID_AF or a temporary public key in AF's session establishment request message. That is, A-KID or A-KID_AF may be included in the session establishment request message. In case where the AF is a 3rd party server, the corresponding request may be made through NEF.

In operation 3-11, the AF may request an AKMA application key by providing (delivering) the A-KID or A-KID_AF or temporary public key received from the UE in operation 3-10 and its own ID, AF_ID, to the AAnF. The AF may transmit Naanf_AKMA_ApplicationKey_Get_Request including A-KID or A-KID_AF and AF_ID.

In operation 3-12, the AAnF may find K_akma corresponding to the A-KID or A-KID_AF received from the AF. If the AAnF cannot find the corresponding K_akma, the AAnF may determine that the AF has transmitted A-KID_AF. In case where A-KID_AF is delivered, it is the case where RID+(A-TID|AF_ID)@HID is delivered, where A-TID and AF_ID (A-TID|AF_ID) are encrypted. Therefore, the AAnF cannot find A-TID without a decryption process for the encrypted A-TID|AF_ID and therefore cannot find K_akma corresponding to A-TID. Conversely, in case where the AAnF cannot find K_akma from the information/message received from the AF, it corresponds to a case where the AF has transmitted A-KID_AF. If the AAnF has found the corresponding K_akma, operation 3-13 may not be performed. In other words, in case of the A-KID being transmitted is in case of RID+A-TID@HID being transmitted and the A-TID is not encrypted. Therefore, the AAnF may find the K_akma corresponding to the received A-KID without decryption. Alternatively, in operation 3-7, if the AAnF has received an “indicator indicating that the UE protects and transmits the A-KID using the public key of the AAnF” from the AUSF and has found K_akma corresponding to the A-KID or A-KID_AF transmitted by the AF, the AAnF may determine that there is an attacker's attack and reject the corresponding request. The case where the AAnF has received an “indicator indicating that the UE protects and transmits the A-KID using the public key of the AAnF” corresponds to a case where the AAnF is required or expected to receive A-KID_AF to which the above encryption is applied. Therefore, unlike this, in case where the AAnF has received A-KID or found K_akma without decrypting the encryption from A-KID_AF, it may be identified as an attacker's attack.

In operation 13, the AAnF may obtain A-KID by decrypting the encrypted part of A-KID_AF using its private key and find the corresponding K_akma. Alternatively, if the AAnF has received the UE's temporary public key in operation 3-11, the AAnF generates a session key using its private key and temporary public key and then uses the session key to decrypt the encrypted part of A-KID_AF to obtain A-KID. The AAnF may generate K_af using K_akma and AF_ID if the AF_ID obtained from the decrypted part matches the ID of the AF that has made the request. If the AF_ID obtained from the decrypted part does not match the ID of the AF that has made the request, the AAnF may reject the AF's request.

In operation 3-14, the AAnF may deliver K_af, the valid time of K_af, and the UE ID (for example, in case where the AF is the service provider's AF, it may be SUPI, and in case where the AF is a 3rd party's AF, it may be GPSI) to the AF. That is, the AAnF may transmit Naanf_AKMA_ApplicationKey_Get_Response including K_af, valid time of K_af, and UE ID. In case where the AF is a third-party server, the corresponding response may be transmitted through NEF.

In operation 3-15, the AF that has received K_af may respond to the application session creation request received from the UE in operation 3-10 and may perform secure communication using K_af.

Although not shown in the drawing, the UDM may have the public key of the AAnF key and the validity time information of the public key. If the validity time of the public key of the AAnF has expired and the AAnF re-registers a new public key and the validity time of the public key, or if the AAnF has generated a new public key/private key of the AAnF and has registered the public key with the UDM even if the public key of the AAnF has not been managed with validity time, the UDM may provide the UE with new public key information (newly generated public key of the AAnF and/or validity time) through the UE parameters update (UPU) process, and the UE may discard the existing public key of the AAnF and valid time and store new public key and/or valid time. And/or, the UE may perform the above-described procedure using the new public key.

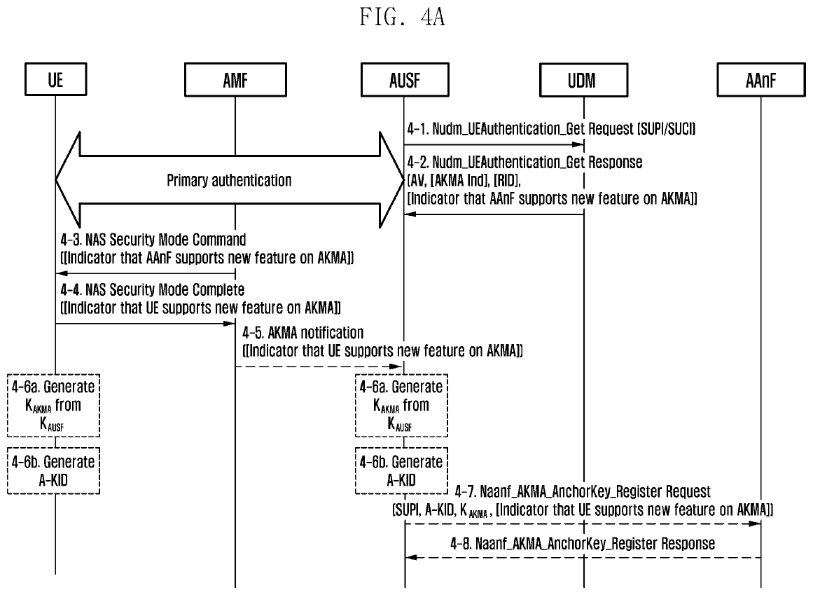

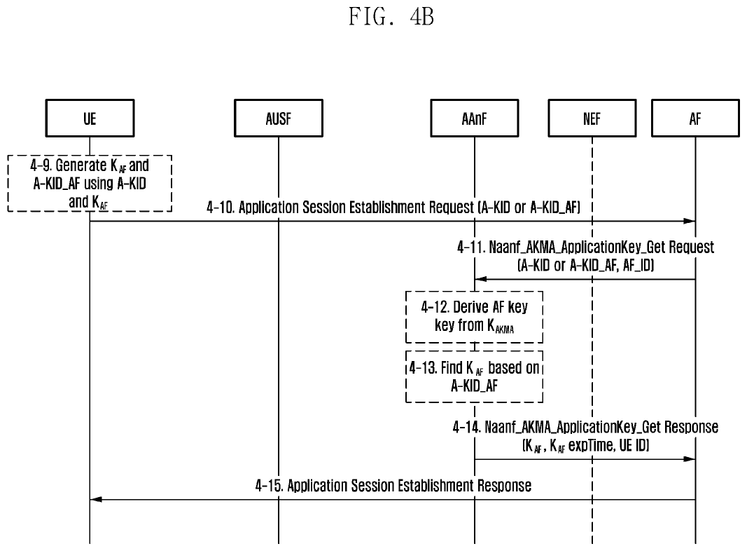

FIG. 4A is a flowchart illustrating a UE authentication process and a process for generating material related to AKMA according to an embodiment of the disclosure.

FIG. 4B is a flowchart illustrating a process for protecting and providing A-KID by a UE to an AF according to an embodiment of the disclosure.

Various modifications may be made to the method illustrated in the flowcharts of FIGS. 4A and 4B. For example, although shown as a series of operations, various operations in each figure may overlap, occur in parallel, occur in a different order, or occur multiple times. In other examples, operations may be omitted or replaced with other operations.

For the procedures illustrated in FIGS. 4A and 4B, one or more of the following configurations may be performed in advance.

### First Pre-Configuration

The AAnF may also register in the UDM that it may operate even if the UE does not transmit A-KID as is. This may mean that the AAnF supports an operation according to an embodiment described later.

In operation 4-1, the AUSF may request the Nudm_UEAuthentication_GetRequest service by providing SUPI or SUCI to the UDM.

In operation 4-2, if the UDM has received SUCI in operation 4-1, the UDM may convert SUCI to SUPI, and if the UDM has received SUPI, the UDM may find K, a long term credential for the corresponding SUPI. K, a long term credential, may be a value stored in the USIM and UDM of the UE. The UDM may generate an authentication vector (AV) (for example, including CK′ and IK′ generated from K in case of EAP-AKA′, or K_ausf in case of 5G-AKA) using K of the corresponding UE. In response to operation 4-1, the UDM may transmit Nudm_UEAuthentication_GetResponse including at least one of an authentication vector, an AKMA indication indicating that the corresponding UE may use an AKMA service, a routing indicator (RID) used to find the AAnF, and an indicator indicating that the AAnF may operate even if the UE does not transmit the A-KID as is. The AUSF that has received the authentication vector may obtain K_ausf (for example, in case of EAP-AKA′, the AUSF may directly obtain K_ausf using CK′ and IK′, and in case of 5G-AKA, the AUSF may receive the K-ausf generated from the UDM). The AUSF may generate K_seaf from the K_ausf and deliver the K_seaf to the SEAF of a serving network, and the SEAF may use the K_seaf to generate K_amf and then deliver the K_amf to the AMF. The above keys (K_ausf, K_seaf, K_amf, etc.) may also be generated in the UE using the same algorithm and input values. However, the order of generating may be simultaneous or different.

In operation 4-3, the AMF may transmit a non-access stratum (NAS) security mode command message by adding an indicator indicating that the AAnF may operate even if the UE does not transmit the A-KID as is, to the NAS security mode command message. That is, the NAS security mode command message may include an indicator (that AAnF supports new feature on AKMA) indicating that the AAnF may operate even if the UE does not transmit the A-KID as is. When the UE, which has received the corresponding indicator, transmits A-KID to the AF, the UE may determine that the UE does not transmit the A-KID as is, but must protect (encrypt) and transmit the A-KID according to a promised method (which will be described in detail below in operation 4-9). The AMF may identify cipher and integrity protection algorithms related to transmission and reception of the NAS messages to and from the UE. The AMF may identify the cipher and integrity protection algorithms related to transmission and reception of the NAS messages based on the information on cipher and integrity protection algorithms supported by the UE received from the UE. The AMF may generate a chipper key or integrity protection key for NAS based on the identified algorithm and K_amf, etc. The AMF may transmit the NAS security mode command message with integrity protection using the generated integrity protection key for the NAS. The NAS security mode command message may be a first integrity-protected message among NAS messages. According to one embodiment, an integrity-protected message may not be arbitrarily modified by other entities until it is received by the UE. The NAS message may include at least one of a cipher algorithm and integrity protection algorithm selected by the AMF. Alternatively, although not shown in the figure, the indicator (that AAnF supports new feature on AKMA) indicating that the AAnF may operate even if the UE does not transmit the A-KID as is may be transmitted through a cipher or integrity-protected message (for example, a registration complete message) rather than the NAS security mode command message.

In operation 4-4, the UE may transmit, to the NAS security mode complete message, an indicator indicating that the UE does not transmit A-KID as is but protect and transmits the A-KID according to a promised method. That is, the NAS security mode complete message may include an indicator indicating that the UE does not transmit A-KID as is but the UE protects and transmits the A-KID according to a promised method. According to one embodiment, the UE may generate a cipher key and integrity protection key for the NAS based on the cipher algorithm and integrity protection algorithm received from the AMF in operation 4-3. The UE may transmit a subsequent NAS message, including the NAS security mode complete message, based on the generated keys with cipher and integrity protections.

In operation 4-5, the AMF may inform the AUSF of the indicator received from the UE in operation 4-4.

In operation 4-6a and operation 4-6b, the UE and AUSF may generate K_akma and A-KID. Regarding the order of generating the above parameters, the UE and AUSF may generate them simultaneously or at different times. The UE and AUSF may generate K_akma using input values such as K_ausf, SUPI, and the string “AKMA” generated in operation 4-2. The A-KID is basically an ID representing K_akma and may include username@realm. The Username part may include routing indicator (RID) and AKMA temporary Identifier (A-TID), and the realm part may include home network identifier. The A-TID may be generated using the string “A-TID”, SUPI, K_ausf, etc. as an input.

In operation 4-7, the AUSF may transmit to the AAnF including at least one of K_akma, A-KID, SUPI, and an indicator indicating that the UE does not transmit A-KID as is but protects and transmits the A-KID according to a promised method. That is, the AUSF may transmit a key registration request message (Naanf_AKMA_AnchorKey_RegisterRequest) including at least one of K_akma, A-KID, SUPI, and an indicator indicating that the UE does not transmit A-KID as is but the UE protects and transmits the A-KID according to a promised method.

The AAnF, which has received this, may pre-generate K_af for K_akma and all allowed AF IDs. Further, the AAnF may protect the A-TID part of A-KID with K_af (using algorithms such as cipher algorithm, hash algorithm, etc.) and store it. The method for storing the protected A-TID part of A-KID by the AAnF may be a method such as A-KID|AF1 ID, K_af1, KDF(A-TID, K_af1)|AF2 ID, K_af2, KDF(A-TID, K_af2)|, and the like (KDF: key derivation function). That is, (1) A-KID, (2) AF1 ID, K_af1, A-TID encrypted based on K_af1, (3) AF2 ID, K_af2, A-TID encrypted based on K_af2, and the like may be combined/concatenated and stored.

In operation 4-8, the AAnF may respond to the key registration request message. The AAnF may transmit a key registration response message (Naanf_AKMA_AnchorKey_RegisterResponse) in response to the key registration request message.

In operation 4-9, if the UE has received the indicator indicating that the AAnF may operate even if the UE does not transmit A-KID as is in operation 4-3, the UE may first generate K_af using K_AKMA and AF_ID. The UE may use the generated K_af to protect the A-TID of the A-KID (using algorithms such as cipher algorithm, hash algorithm, and the like) and replace the existing A-TID part. Using the above method, the UE may also generate A-KID_AF.

In operation 4-10, the UE may transmit A-KID or A-KID_AF in AF's session establishment request message. That is, A-KID or A-KID_AF may be included in the session establishment request message. In case where the AF is a 3rd party server, the corresponding request may be made through NEF.

In operation 4-11, the AF may request an AKMA application key by providing the A-KID or A-KID_AF received from the UE in operation 4-10 and its own ID, AF_ID, to the AAnF. The AF may transmit Naanf_AKMA_ApplicationKey_Get_Request including A-KID or A-KID_AF and AF_ID.

In operation 4-12, the AAnF may find K_akma corresponding to the A-KID or A-KID_AF received from the AF. If the AAnF cannot find the corresponding K_akma, the AAnF may determine that the AF has transmitted A-KID_AF. If the AAnF has found the corresponding K_akma, operation 4-13 may not be performed. Alternatively, in operation 4-7, if the AAnF has received an “indicator indicating that the UE does not transmit A-KID as is but protects and transmits the A-KID according to a promised method” from the AUSF and has found K_akma corresponding to the A-KID or A-KID_AF transmitted by the AF, the AAnF may determine that there is an attacker's attack and reject the corresponding request.

In operation 4-13, the AAnF may find K_af based on the information stored in operation 4-7. The AAnF may find the corresponding K_af by comparing the protected part of A-KID_AF received from AF in operation 4-11 with the information stored in operation 4-7. The AAnF may identify whether the AF_ID included in the corresponding information matches the ID of the AF that has made the corresponding request. The AAnF may reject the request from the AF if there is a mismatch.

In operation 4-14, the AAnF may deliver K_af, the valid time of K_af, and the UE ID (in case where the AF is the service provider's AF, it may be SUPI, and in case where the AF is a 3rd party's AF, it may be GPSI) to the AF. That is, the AAnF may transmit Naanf_AKMA_ApplicationKey_Get_Response including K_af, valid time of K_af, and UE ID. The corresponding response may be transmitted through NEF.

In operation 4-15, the AF that has received K_af may respond to the application session creation request received from the UE in operation 10 and may perform secure communication using K_af.

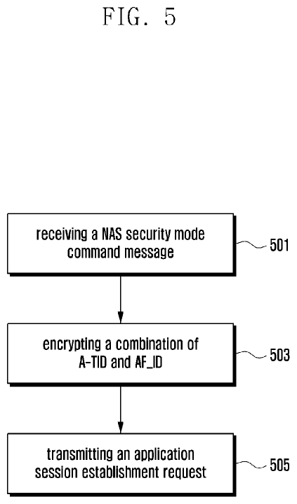

FIG. 5 illustrates an example flowchart for a process performed by a UE according to an embodiment of the disclosure. Various modifications may be made to the method illustrated in the flowcharts of FIG. 5. For example, although shown as a series of operations, various operations in each figure may overlap, occur in parallel, occur in a different order, or occur multiple times. In other examples, operations may be omitted or replaced with other operations.

In operation 501, the UE may receive, from an access and mobility management function (AMF), a non-access stratum (NAS) security mode command message including information on a public key of an authentication and key management for applications (AKMA) anchor function (AAnF).

In operation 503, the UE may encrypt, based on the public key, a combination of an AKMA temporary identifier (A-TID) and an application function identifier (AF_ID) of an application function (AF).

In operation 505, the UE may transmit, to the AF, an application session establishment request including information on the encrypted combination of the A-TID and the AF_ID.

For more detailed information on the operation of the UE according to an embodiment of the disclosure illustrated in FIG. 5, reference may be made to the description of the embodiment of the disclosure described above.

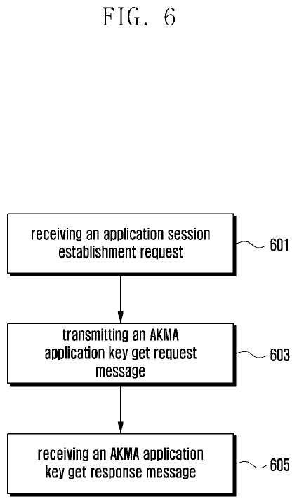

FIG. 6 illustrates an example flowchart for a process performed by an AF according to an embodiment of the disclosure. Various modifications may be made to the method illustrated in the flowcharts of FIG. 6. For example, although shown as a series of operations, various operations in each figure may overlap, occur in parallel, occur in a different order, or occur multiple times. In other examples, operations may be omitted or replaced with other operations.

In operation 601, the AF may receive, from a user equipment (UE), an application session establishment request including a combination of an authentication and key management for applications (AKMA) temporary identifier (A-TID) and a first application function identifier (AF_ID). The combination of the A-TID and the first AF_ID may be encrypted based on a public key of an AKMA anchor function (AAnF).

In operation 603, the AF may transmit, to the AAnF, an AKMA application key get request message including information on the encrypted combination of the A-TID and the first AF_ID and information on a second AF_ID of the AF.

In operation 605, the AF may receive, from the AAnF, an AKMA application key get response message including information on a common key associated with the first AF_ID and an AKMA key identifier (A-KID) in case that the first AF_ID is identical to the second AF_ID, The A-KID may include the A-TID.

For more specific details of the operation of the AF according to an embodiment of the disclosure illustrated in FIG. 6, reference may be made to the description of the embodiment of the disclosure described above.

It should be noted that the structural views, example views of control/data signal transmission/reception methods, and example views of operational procedures illustrated in FIGS. 1A, 1B, 2A to 2C, 3A, 3B, 4A, 4B, 5, and 6 are not intended as limiting the scope of the disclosure. In other words, all the components, entities, or operational steps illustrated in FIGS. 1A, 1B, 2A to 2C, 3A, 3B, 4A, 4B, 5, and 6 should not be construed as essential components to practice the disclosure, and the disclosure may be rather implemented with only some of the components without departing from the gist of the disclosure.

The operations of the above-described embodiments may be implemented by providing a memory device storing a corresponding program code in any component of the apparatus. In other words, the controller in the apparatus may execute the above-described operations by reading and executing the program codes stored in the memory device by a processor or central processing unit (CPU).

As described herein, various components or modules in the entity, or UE may be operated using a hardware circuit, e.g., a complementary metal oxide semiconductor-based logic circuit, firmware, software, and/or using a hardware circuit such as a combination of hardware, firmware, and/or software embedded in a machine-readable medium. As an example, various electric structures and methods may be executed using electric circuits such as transistors, logic gates, or application specific integrated circuits.

Methods according to the claims of the disclosure or the embodiments described in the specification may be implemented in hardware, software, or a combination of hardware and software.

In case of being implemented in software, a computer-readable storage medium storing one or more programs (software modules) may be provided. The one or more programs stored in the computer-readable storage medium are configured for execution by one or more processors in an electronic device. The one or more programs may include instructions that cause the electronic device to perform the methods in accordance with the claims of the disclosure or the embodiments described in the specification.

The programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), a digital versatile disc (DVD) or other types of optical storage device, or a magnetic cassette. Alternatively, the programs may be stored in a memory including a combination of some or all of them. Also, each memory component may include a plurality of memories.

The program may also be stored in an attachable storage device that may be accessed over a communication network including the Internet, an intranet, a local area network (LAN), a wide area network (WAN), or a storage area network (SAN), or a combination thereof. The storage device may be connected to an apparatus performing the embodiments of the disclosure through an external port. Furthermore, a separate storage device in the communication network may access an apparatus that performs the embodiments of the disclosure.

In the above described embodiments of the disclosure, a component included in the disclosure is represented in a singular or plural form according to the presented specific embodiment. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
receiving, from an access and mobility management function (AMF), a non-access stratum (NAS) security mode command message including information on a public key of an authentication and key management for applications (AKMA) anchor function (AAnF);
encrypting, based on the public key, a combination of an AKMA temporary identifier (A-TID) and an application function identifier (AF_ID) of an application function (AF); and
transmitting, to the AF, an application session establishment request including information on the encrypted combination of the A-TID and the AF_ID.

2. The method of claim 1, further comprising:
transmitting a NAS security mode complete message including information indicating the A-TID to be transmitted with encryption,
wherein (i) the encryption of the combination of the A-TID and the AF_ID and (ii) transmission of the application session establishment request, is performed after the transmission of the NAS security mode complete message.

3. The method of claim 1, further comprising:
receiving, from the AF, an application session establishment response; and
identifying, based on the application session establishment response, that AKMA-based security communication with the AF using a common key is available,
wherein the common key is obtained based on the AF_ID and an AKMA key, and
wherein the A-TID is included an AKMA key identifier (A-KID) for the AKMA key.

4. The method of claim 1,
wherein the NAS security mode command message includes information on a valid time of the public key, and
wherein the encryption of the combination of the A-TID and the AF_ID is performed based on the public key in case that the public key is identified as valid based on the valid time.

5. The method of claim 1, wherein in case that other information on other public key is received prior to the reception of the NAS security mode command message:
the other public key is discarded, and
the public key is used for the encryption.

6. A user equipment (UE) in a communication system, the UE comprising:
a transceiver; and
a processor coupled with the transceiver and configured to:
receive, from an access and mobility management function (AMF), a non-access stratum (NAS) security mode command message including information on a public key of an authentication and key management for applications (AKMA) anchor function (AAnF),
encrypt, based on the public key, a combination of an AKMA temporary identifier (A-TID) and an application function identifier (AF_ID) of an application function (AF), and
transmit, to the AF, an application session establishment request including information on the encrypted combination of the A-TID and the AF_ID.

7. The UE of claim 6,
wherein the processor is further configured to transmit a NAS security mode complete message including information indicating the A-TID to be transmitted with encryption, and
wherein (i) the encryption of the combination of the A-TID and the AF_ID and (ii) transmission of the application session establishment request, is performed after the transmission of the NAS security mode complete message.

8. The UE of claim 6,
wherein the processor is further configured to:
receive, from the AF, an application session establishment response, and
identify, based on the application session establishment response, that AKMA-based security communication with the AF using a common key is available,
wherein the common key is obtained based on the AF_ID and an AKMA key, and
wherein the A-TID is included an AKMA key identifier (A-KID) for the AKMA key.

9. The UE of claim 6,
wherein the NAS security mode command message includes information on a valid time of the public key, and
wherein the encryption of the combination of the A-TID and the AF_ID is performed based on the public key in case that the public key is identified as valid based on the valid time.

10. The UE of claim 6, wherein in case that other information on other public key is received prior to the reception of the NAS security mode command message:
the other public key is discarded, and
the public key is used for the encryption.

11. A method performed by an application function (AF) in a communication system, the method comprising:
receiving, from a user equipment (UE), an application session establishment request including a combination of an authentication and key management for applications (AKMA) temporary identifier (A-TID) and a first application function identifier (AF_ID), wherein the combination of the A-TID and the first AF_ID is encrypted based on a public key of an AKMA anchor function (AAnF);
transmitting, to the AAnF, an AKMA application key get request message including information on the encrypted combination of the A-TID and the first AF_ID and information on a second AF_ID of the AF; and
receiving, from the AAnF, an AKMA application key get response message including information on a common key associated with the first AF_ID and an AKMA key identifier (A-KID) in case that the first AF_ID is identical to the second AF_ID, wherein the A-KID includes the A-TID.

12. The method of claim 11, further comprising:
transmitting, to the UE, an application session establishment response associated with AKMA-based security communication with the UE using the common key being available.

13. The method of claim 11, wherein the public key is associated with a private key of the AAnF.

14. The method of claim 11, wherein the AKMA application key get response message includes information on a valid time of the common key.

15. The method of claim 11, wherein the AKMA application key get response message is not received in case that the first AF_ID is different from the second AF_ID.

16. An application function (AF) in a communication system, the AF comprising:
a transceiver; and
a processor coupled with the transceiver and configured to:
receive, from a user equipment (UE), an application session establishment request including a combination of an authentication and key management for applications (AKMA) temporary identifier (A-TID) and a first application function identifier (AF_ID), wherein the combination of the A-TID and the first AF_ID is encrypted based on a public key of an AKMA anchor function (AAnF),
transmit, to the AAnF, an AKMA application key get request message including information on the encrypted combination of the A-TID and the first AF_ID and information on a second AF_ID of the AF, and
receive, from the AAnF, an AKMA application key get response message including information on a common key associated with the first AF_ID and an AKMA key identifier (A-KID) in case that the first AF_ID is identical to the second AF_ID, wherein the A-KID includes the A-TID.

17. The AF of claim 16, wherein the processor is further configured to transmit, to the UE, an application session establishment response associated with AKMA-based security communication with the UE using the common key being available.

18. The AF of claim 16, wherein the public key is associated with a private key of the AAnF.

19. The AF of claim 16, wherein the AKMA application key get response message includes information on a valid time of the common key.

20. The AF of claim 16, wherein the AKMA application key get response message is not received in case that the first AF_ID is different from the second AF_ID.
